(19) United States
(12) Patent Application Publication
(10) Pub. No.: US 2008/0257479 A1
(43) Pub. Date: Oct. 23, 2008

(54) Process for Producing Adhesive Type Heater

(76) Inventors: Kaoru Usui, Tochigi-shi (JP); Yoshikazu Sakamaki, Tochigi-shi (JP); Yukio Urume, Tochigi-shi (JP); Kenichi Iwamoto, Tochigi-shi (JP); Hirotaka Omae, Tochigi-shi (JP)

Correspondence Address: YOUNG & THOMPSON, 209 Madison Street, Suite 500, ALEXANDRIA, VA, 22314, US

(21) Appl. No.: 10/592,785

(22) PCT Filed: Feb. 14, 2005
(86) PCT No.: PCT/JP2005/002122

§ 371 Date: May 5, 2008

(30) Foreign Application Priority Data
Mar. 16, 2004 (JP) 2004-073733

(51) Int. Cl. B32B 37/12

(52) U.S. Cl. 156/145

(57) ABSTRACT

A process for producing an adhesive type heat-generation according to the present invention comprises an adhesive layer forming process 30 and a heating composition filling and the adhesive layer gathering process 60. In the adhesive layer forming process, the hydrous hydrophilic adhesive layer is spread and sandwiched between a release film and a base film while continuously feeding the release film and the base film from respective rolls to form the adhesive layer. In the heating composition filling and the adhesive layer gathering process 60, the base film is placed on the air-permeable film at its one side opposite to the adhesive layer, peripheral edges of the films are melt-bonded to form a heat-sealed peripheral edge and thus to form a pocket between the base film and the air-permeable film for containing the heating composition. At the same time, an adhesive of the adhesive layer is pushed and gathered inside the heat-sealed peripheral edge. And, the heating composition layer is formed in the pocket and sealed the pocket at the same time of the formation of the pocket.

### TECHNICAL FIELD

The present invention relates to a process for producing an adhesive type heat-generation being adhered to a skin of a body directly, and in particular, to a process for mass-producing an adhesive type heat-generation employing a hydrous hydrophilic adhesive.

### BACKGROUND ART

Heat-generations such as disposable body warmers include an adhesive type being directly adhered to a skin of a body. Such an adhesive type heat-generation transmits heat to the skin directly and therefore has a higher heat transition efficiency than a heat-generation being adhered to a body through clothes. However, an adhesive capable of being directly adhered to a skin requires both safety and comfort. Such an adhesive includes a non-aqueous type adhesive and a hydrophilic type adhesive. An exemplary non-aqueous adhesive includes an acrylic based adhesive and a SIS based adhesive.

On the contrary, a hydrophilic type adhesive has an advantage of being sticky and thus having a high adherence. As such a hydrophilic type adhesive, for example, an adhesive base material comprising an aqueous gel produced by employing water-soluble polymer crosslinking agent is given. The adhesive has to be left to stand for 2 to 3 days at high temperature for curing because of its flowability just after production. In a procedure in which a predetermined area is coated with a predetermined amount of the adhesive, it is preferable to treat the adhesive keeping flowability; however, this causes the following problem. For example, if a sheet will be coated with the adhesive on its one surface and then rolled into a roll shape for use in a coating work, it is difficult to form the roll shaped sheet. Because, if the sheet will be rolled into a roll shape, the adhesive will slant owing to its weight or the adhesive will drip from an end of the roll. Meanwhile, if a sheet will be thinly coated with a thick adhesive and then rolled into a roll, the aforesaid problem is not caused. However, when a roll shaped adhesive film will be employed, in order to bond a heating layer to an adhesive film layer together using a hot-melt means, the resultant product has a four-layered structure (including an air-permeable film, a base sheet, an adhesive sheet layer and a release sheet), causing less flexibility and thus less fitness and adhesion to a body. In addition, since the thick adhesive having less flowability is thinly spread, the advantage of the hydrous hydrophilic adhesive is diminished.

And, from a viewpoint of productivity, it is necessary to incorporate a hot-melting apparatus and the like into a production equipment, thereby causing the production equipment complicate and increasing production costs.

In a method in which a base film is coated with an adhesive just after the production, when the base film coated with the adhesive is cut by a cutter, the adhesive will drip from its cut section due to its flowability. And, the dripped adhesive may be adhered to the cutter or a transfer roll resulting in problems of cutting failure in the cutter and transfer failure in the transfer roll. So, an improvement for such problems is disclosed in Patent Literature 1.

Patent Literature 1: Japanese published unexamined application 2004-50486.

### DISCLOSURE OF THE INVENTION

### Problems to be Resolved by the Invention

In view of the problems, the object of the present invention is to provide an effective and stable process for mass-producing an adhesive type heat-generation employing a hydrous hydrophilic adhesive.

### Means of Solving the Problems

A process for producing an adhesive type heat-generation according to the present invention is a process for producing an adhesive type heat-generation comprising a release film, a hydrous hydrophilic adhesive layer, a base film, a heating composition layer and an air-permeable film stacking up in the order comprises A process in which the hydrous hydrophilic adhesive layer is spread and sandwiched between the release film and the base film at a predetermined thickness while continuously feeding the release film and the base film from respective rolls to form the adhesive layer; B process in which the base film is placed on the air-permeable film at its one side opposite to the adhesive layer, peripheral edges of the films are melt-bonded to form a heat-sealed peripheral edge and thus to form a pocket between the base film and the air-permeable film for containing the heating composition, and simultaneously therewith, an adhesive of the adhesive layer is pushed and gathered inside the heat-sealed peripheral edge; and C process in which the heating composition layer is formed in the pocket and sealed the pocket at the same time of, or, before or after the formation of the pocket.

According to the present invention, after forming the adhesive layer, both peripheral edges of the base film and the air-permeable film are heat-sealed using a pair of seal rolls and the heating composition is filled, and at the same time, the adhesive is gathered toward the pocket. So, the filling of the heating composition and the spreading the adhesive layer will perform sequentially using one apparatus.

In the B process according to the present invention, a contour of a planer area on which the adhesive layer is spread can be substantially conformed to a contour of the pocket. Accordingly, it is not necessary to position each contour separately.

In the present invention, the adhesive type heat-generation will be mass-produced by arranging the heat-generation in the longitudinal and width directions of the film, and then the film will be cut along the heat-sealed portions so as to divide each adhesive type heat-generation individually.

In this case, when the sheet, on which pluralities of heat-generations are continuously formed in a row, is cut using a cutter, the sheet is supposed to be cut at heat-sealed portions on which the adhesive scarcely remains because it was pushed forward inside. Therefore, the adhesive will not adhere to the cutter. In addition, the adhesive does not drop from the cut section.

And, in the present invention, a plane on which the adhesive layer is applied is made into a gourd shape, a heart shape or an oval shape.

The present invention does not exclude formation of additive layer or film between or outside of any layers or any films.

### ADVANTAGEOUS EFFECT OF THE INVENTION

As described above, by the present invention, a coating process of an adhesive and a filling process of a heating composition can be successionally carried out at one procedure. Accordingly, a process for mass-producing an adhesive type heat-generation employing a hydrous hydrophilic adhesive effectively can be provided.

### DETAILED DESCRIPTION OF THE PREFERRED EMBODIMENTS

Hereinafter, preferred embodiments of the present invention will be concretely described, referring to the drawings.

First, a structure of an adhesive type heat-generation produced by a process for producing an adhesive type heat-generation according to the present invention will be explained.

FIG. 6 are drawings showing a structure of the adhesive type heat-generation. FIG. 6(A) is a plane drawing and FIG. 6(B) is a cross-section drawing.

An adhesive type heat-generation 1 comprises a release film 3, a hydrous hydrophilic adhesive layer 4, a base film 5, a heating composition layer 6 and an air-permeable layer 7 stacking up in the order from the top of FIG. 6(B). The heating composition 6 may comprise iron powder, activated carbon, wood flour, sodium chloride and water mixed at a predetermined mixing ratio. The heating composition 6 is reacted with oxygen in air and generates heat. In order to prevent the heat-generation 1 from generating heat before use under presence of air, the heat-generation 1 is hermetically sealed in an airtight package (not shown).

The base film 5 and the air-permeable film 7, having the same shape, are sealed at their peripheral edges 11 to form a pocket 13 between the films. In this example, each of the base film 5 and the air-permeable film 7 has a rectangle shape about 10.5 cm in length and about 7 cm in width. The peripheral edge 11 has a width of 5 to 8 mm. In the pocket 13, the heating composition 8 is contained. As the base film 5, for example, a sheet laminating nonwoven nylon with polyethylene film may be given. As the air-permeable film 7, for example, a porous film laminating nonwoven nylon with fine-porous polyethylene sheet may be given.

On an outer surface of the base film 5, the hydrous hydrophilic adhesive layer 4 is spread. As the hydrous hydrophilic adhesive, for example, aqueous gel produced by employing water-soluble polymer crosslinking agent is given. The adhesive layer 4 is spread, not over the whole area of the base film 5, but over an inside area (the pocket 13 framed by a contour C) within the peripheral edge (a heat-sealed edge) 11. This is because, the adhesive has flowability just after production as described above and thus may leak from the edge of the film during curing of the adhesive after coating Consequentially, in order to prevent the adhesive from leaking outside the film, the peripheral edge 11 is provided.

On an outer surface of the adhesive layer 4, the release film 3 is adhered for protection of the adhesive layer 3. The release film 3, having the same shape as the base film 3 and the air-permeable film 7, may be made of, for example, a transparent film coated with silicon resin on one surface thereof. The release film 3 is adhered to the base film 5 at their peripheral edges 11 via a thin layer of the adhesive (not shown) by an after-mentioned process.

The heat-generation 1 will be marketed after being left to stand for 2 to 3 days at high temperature for curing the adhesive after spreading the adhesive layer 4.

In use, pullout the heat-generation 1 from the package, peel the release film 3 from the heat-generation 1 and apply the adhesive layer 4 directly to a skin to be heated. Then, air will be penetrated through the air-permeable film 7 into the pocket 13 and reacted with the heating composition 6, thereby to generate heat. The heat will be transmitted to the skin through the base film 5 and the adhesive layer 4.

Next, a process for producing the heat-generation 1 will be explained.

FIG. 1 is a drawing showing a process for producing an adhesive type heat-generation according to the present invention.

The process for producing an adhesive type heat-generation 1 mainly comprises an adhesive layer forming process (A process) 30; a pocket forming and adhesive gathering process (B process) and a pocket sealing process (C process) 60; a cutting process 90; a sealing process; and an adhesive curing process. An explanation of an adhesive production process and a heating composition production process are omitted.

The adhesive layer forming process (A process) 30 will be explained in detail.

In the adhesive layer forming process 30, the hydrous hydrophilic adhesive produced by the adhesive production process is spread and sandwiched between the release film 3 and the base film 5 at a predetermined thickness to form the adhesive layer 4. Each original form of the release film 3 and the base film 5 is a strip-shaped product, having substantially the same width and being rolled into rolls 33 and 35 respectively. This embodiment shows continuous process for producing the heat-generations 1 in a longitudinal direction with the heat-generations 1 being arranged in two lines in the width direction. A number of lines of the heat-generations to be produced in the width direction is not limited to two; may be one or three.

The adhesive layer forming process 30 is provided with a coater roll 37 and a clearance roll 39, each oppositely arranged, and a hopper 41 for containing the hydrous hydrophilic adhesive above the coater roll 37. The coater roll 37 is positioned apart from the clearance roll 39 at a predetermined distance (a clearance, for example, about 0.5 to 5 mm). The coater roll 37 rotates clockwise in the figure; the clearance roll 39 rotates counterclockwise at the same rotating speed as the coater roll 37. The hopper 41 is arranged above the coater roll 37, being across the width of the coater roll 37.

The clearance roll 39 is movable forward and backward to the coater roll 37, whereby the distance (the clearance) between the rolls is variable.

The release film 3 fed from the release film roll 33 is introduced to the coater roll 37 through a tension roll 43. Then, the adhesive is spread onto the release film 3 winded around the coater roll 37 from the hopper 41. Note that the adhesive is spread to an inside area at a predetermined distance (for example, 10 to 15 mm) from the both side edges of the release film 3 (as will be described in detail). This is to prevent the adhesive from leaking from the edge of the film 3 owing to its flowability.

An amount of the adhesive to be spread is 100 g/m² to 4000 g/m².

The base film 5 fed from the base film roll 35 is introduced to the clearance roll 39 through a tension roll 45. And, at a portion at which the coater roll 37 and the clearance roll 39 are faced each other, the base film 5 is placed on the adhesive which is spread to the release film 3. Because of adherence of the adhesive, the base film 5 is adhered to the adhesive layer. At the same time, the adhesive is sandwiched between the base film 5 and the release film 3 to form the adhesive layer 4 having a thickness of a clearance between the rolls.

FIG. 2 are drawings showing each layer passed the adhesive layer forming process, FIG. 2(A) is a plane drawing and FIG. 2(B) is a cross-sectional drawing.

As mentioned above, after the adhesive layer forming process, a three-layered film in which the adhesive layer 4 and the release film 3 are placed on the base film 5 is provided. The adhesive layer 4, as mentioned above, is spread, not on the full width of the base film 4 and the release film 3, but on an inside area at a distance W1 of about 10 to 15 mm from the both side edges of the films. The adhesive layer 4 has a thickness of 0.5 to 1.5 mm.

The three-layered film 50 is introduced to the heating composition filling and adhesive gathering process 60 via a tension roll 47.

FIG. 3 are drawings schematically showing the pocket forming and adhesive gathering process (B process) and the pocket sealing process (C process), FIG. 3(A) is a perspective drawing, FIG. 3(B) is a cross-sectional drawing and FIG. 3(C) is an enlarged drawing showing a seal roll used in the processes.

In the pocket forming and the adhesive layer gathering process (B process) and the pocket sealing process (C process) 60, the base film 5, on which the adhesive layer 4 is formed, is placed on the air-permeable film 7 at its side opposite to the adhesive layer 4, and the base film 5 and the air-permeable film 7 are heat-sealed at their peripheral edges 11 to form the pocket 13 between the base film 5 and the air-permeable film 7, in which the heating composition 6 will be contained in the pocket 13. Simultaneously, the adhesive of the adhesive layer 4 is gathered by being pushed inside from the peripheral edge (the heat-sealed portion) 11. Then, after filling the heating composition 6 in the formed pocket 13, the pocket 13 is sealed.

The pocket forming and the adhesive gathering process and the pocket sealing process 60 is provided with three of seal roll pairs 61A, 61B and 61C, arranged at three levels in the height direction, a hopper 67 containing the heating composition and a measuring apparatus 69 weighing a weight of the heating composition, from the upstream to the downstream, as shown in FIG. 1. As shown in FIG. 3(B), each of the seal roll pairs 61A, 61B and 61C comprises a pair of seal rolls 63 and 65 being in contact each other at outer surfaces of the rolls.

As shown in FIG. 3(B) and FIG. 3(C), each of the seal rolls 63 and 65 is provided with a plurality of rectangle-shaped concave portions 71 and a border portion 73 which separates the concave portions 71 in the lateral direction (a width direction of the roll) and in the longitudinal direction (a circumferential direction of the roll) on its outer surface. The concave portions 71 are arranged at two rows in the width direction of the roll and at four rows in the circumferential direction of the roll. The concave portion 71 is corresponded to the pocket 13 of the heat-generation and has almost the same size as the pocket 13. The concave portion 71 preferably has a depth of 2 to 4 times the thickness of the adhesive layer.

The border portion 73 has a left circumferential portion 73L, a center circumferential portion 73C, a right circumferential portion 73R in the circumferential direction of the roll, and four transverse portions 73V in the width direction of the roll. The border portions 73 are corresponded to the peripheral edge 11 of the heat-generation. The center circumferential portion 73C and the transverse portions 73V have a width (10 to 16 mm) of about 2 times the width of the peripheral edge 11 (the heat sealed portion) of the heat-generation; the left and right circumference portions 73L and 73R have the same width (5 to 8 mm) as the heat-sealed portion.

Each of the seal rolls is heated to 100 to 180° C.

In each of the heat roll pairs 61A, 61B and 61C, the rolls 63 shown in the left in the figure rotate clockwise; the rolls 65 shown in the right in the figure rotate counterclockwise at the same rotating speed as the rolls 63. In addition, the rolls 63 shown in the left in the figure and the rolls shown in the right in the figure are positioned such that the concave portions 71 and the border portion 73 are confirmed each other in the width direction and in the circumferential direction when each roll rotates.

Above the rolls 63 and 65 of the uppermost seal roll pair 61A, the hopper 67 containing the heating composition is arranged (as shown in FIG. 1). The hopper 67 is equipped with the measuring apparatus 69 at its under portion, at which the heating composition is weighed to a predetermined amount (for example, 10 to 20 g). The measuring apparatus 69 is formed with two outlets 69a arranged in the width direction of the seal roll. The weighed heating composition is discharged through each outlet 69a.

To one seal roll 63 of the uppermost seal roll pair 61A, the three-layered film 50 is fed. The three-layered film 50 comprises the base film 5, the adhesive layer 4, and the release film 3 stacked up in the order from top to bottom, as shown in FIG. 2(B), and the release film 3 directly contacts the seal roll 63, and the base film 5 is placed outside. To another seal roll 65, the air-permeable film 7 is fed from the roll 73 via a tension roll 75. An original form of the air-permeable film 7 is a strip-shaped product, having the same width as that of the base film 5 and the release film 3 and being rolled into a roll.

When the three-layered film 50 and the air-permeable film 7 are fed by the seal rolls 63 and 65 and come to the contact zone of the rolls, the base film 5 of the three-layered film 50 becomes in contact with the air-permeable film 7. And, since the rolls 63 and 65 rotate at the same speed such that the concave portions 71 and the border portions 73 will be confirmed each other, the border portions 73 are in contact each other; the concave portions 71 are not in contact at the contact zone. That is, the three-layered film 50 and the air-permeable film 7 are pressed each other by the border portions 73 of the rolls 63 and 65 at the contact zone. Since the both rolls 63 and 65 are heated, the base film 5 and the air-permeable film 7 are heat-sealed at their peripheral edges.

FIG. 4 is a drawing schematically showing a state in which the films are passing through the contact zone.

FIG. 5 are drawings showing each layer after passing the contact zone, FIG. 5(A) is a plane drawing and FIG. 5(B) is a cross-sectional drawing.

On passing the three-layered film 50 and the air-permeable film 7 through the contact zone of the heat rolls (not shown in FIG. 4) from the upstream (the upper side of the figure) to the downstream (the lower side of the figure), first, the heat rolls meet at their transverse portions 73V. As the result, the base film 5 and the air-permeable film 7 are heat-sealed at their peripheral edges (lateral seal) 11V-1. Then, following the transverse portions, the heat rolls come to contact at their left, right and center circumferential portions 73L, 73R and 73C. As the result, following the peripheral edges 11V-1, the films are heat-sealed at the peripheral edges 11L, 11R and 11C (longitudinal seals). During the procedure, the heating composition begins to be filled in a space (the pocket 13) surrounded by the three peripheral edges 11L, 11R and 11V through the outlets 69a of the measuring apparatus 69. And, by the time the almost entire peripheral edges 11L, 11R and 11C are heat-sealed, the heating composition is being supplied through the outlets 69a of the measuring apparatus 69. Then, the rolls become in contact at their next transverse portion 73V thereby to heat-seal the peripheral edges 11V-2 of the films 5 and 7. As the result, as shown in FIG. 5(A), the heating composition will be sealed in the pocket 13 of which all four sides are heat-sealed. The heating composition inside the pocket 13 is sandwiched between the concave portions 71 of the rolls 63 and 65 thereby to have a uniform thickness.

Meanwhile, the adhesive 4 sandwiched between the base film 5 and the release film 3 is pressed by the border portions 73 of the rolls 63 and 65 from both sides at the contact zone. Since the border portions 73 of the rolls 63 and 65 are tightly in contact each other and also the adhesive has flowability, a greater part of the adhesive located at the border portions 73 of the rolls 63 and 65 are pushed out into a portion other than the border portion (mainly, into the concave portions 71 of the rolls). That is, the adhesive spread on the border portions 73 of the rolls 63 and 65 will be transferred to the pocket 13 formed between the base film 5 and the air-permeable film 3.

As shown in FIG. 2, the left and right edges (a width of 10 to 15 mm) of the base film 5 are not coated with the adhesive. On the contrary, the left and right circumferential portions 73L and 73R of the rolls 63 and 65 have a width of 5 to 8 mm, shorter than the width of the left and right edges of the base film 5, in which the edges are not coated with the adhesive. Therefore, the left and right circumferential portions 73L and 73R heat-seals outermost portions of the left and right edges of the base film 5 at a width of 5 to 8 mm; however, does not heat-seal an inside portion (corresponding to the pocket 13) from the outermost portions. So, the adhesive is gathered to the entire area of the pocket 13.

As described above, the almost all of the adhesive provided by the adhesive layer forming process 30 is used for the adhesive layer 4 of the heat-generation 1, thereby causing good process yield of the adhesive.

The middle heat roll pair 61B and the lowermost heat roll pair 61C function in the same way as the uppermost heat roll pair 61A. This can strengthen the sealing strength of the heat-sealed portion 11.

A number of the heat seal roll pairs may be one or two.

After passing each film through the lowermost seal roll pair 61C, a long sheet, in which the heat-generations 1 are arranged in two rows in the width direction and also successively arranged in the longitudinal direction, is formed, as shown in FIG. 5. The sheet 70 is fed to the cutting process 90 via a tension roll 81, as shown in FIG. 1.

In the pocket forming and the adhesive gathering process (B process) and the pocket sealing process (C process) 60 in this embodiment, heat-sealing of the peripheral edges and forming (gathering) of the adhesive layer are carried out using one seal roll pair (also called a die roll); however, a method employing a seal bar may be given. In the seal bar method, a pair of unrotatable plates formed with a concave portion and a border portion are compressed each other.

In the process 60, filling of the heating composition is carried out by failing the weighed heating composition; however, may be carried out by other methods such as a transferring method. In the transferring method, a predetermined amount of heating composition is transferred to a portion corresponded to the pocket using a magnetic roller.

FIG. 7 is a drawing showing the cutting process.

In the cutting process 90, the long sheet 70 is cut in the width direction and the longitudinal direction so as to be made into individual heat-generations 1. The process 90 is provided with roll shaped upper and lower rotary blades 91 and 93, vertically arranged. The rotary blade 91 cuts the long sheet 70 in the width direction at the center (marked by L1 in FIG. 7) of the peripheral edges (lateral seal) 11V. The rotary blade 93 cuts the long sheet 70 in the longitudinal direction at the center (marked by L2 in FIG. 7) of the peripheral edge (longitudinal seal) 11C. Since the adhesive hardly remains on the peripheral edges 11V and 11C, such a trouble that the adhesive may stick to the rotary blades 91 and 93 will not occur. And, as described above, since the adhesive layer 4 has substantially the same contour as the pocket 13 in which the heating composition is contained, the adhesive layer 4 is not displaced with the pocket 13 so that the heat-generation 1 can be successively produced.

In the cutting process 90, a box motion apparatus, a die cut apparatus (a roll type punching apparatus), a mold (Thomson) apparatus, an ultrasonic apparatus and a slitter apparatus may be employed in addition to the rotary blades.

Then, individual heat-generations 1 are fed through a belt conveyer 95 to the package sealing process for sealing in the air-tight package. And, until the adhesive will be cured, the heat-generation 1 sealed in the air-tight package (that is a product) is left to stand for 2 to 3 days at a condition of 30 to 60° C. A production method according to the present invention requires 2 to 3 days for curing the adhesive, but allows continuous production of the heat-generations.

In a process of this embodiment, a rectangle shaped heat-generation is produced. Furthermore, by changing the shape of the concave portion of the seal roll, various shapes of pocket 13 can be formed.

FIG. 8 are drawings showing shapes of the pocket.

The heat-generation 1 shown in FIG. 8(A) has a gourd-shaped pocket 13.

The heat-generation 1 shown in FIG. 8(B) has an oval pocket 13.

The heat-generation 1 shown in FIG. 8(C) has a heart-shaped pocket 13.

### BRIEF DESCRIPTION OF THE DRAWINGS

FIG. 1 is a drawing showing a process for producing an adhesive type heat-generation according to the present invention;

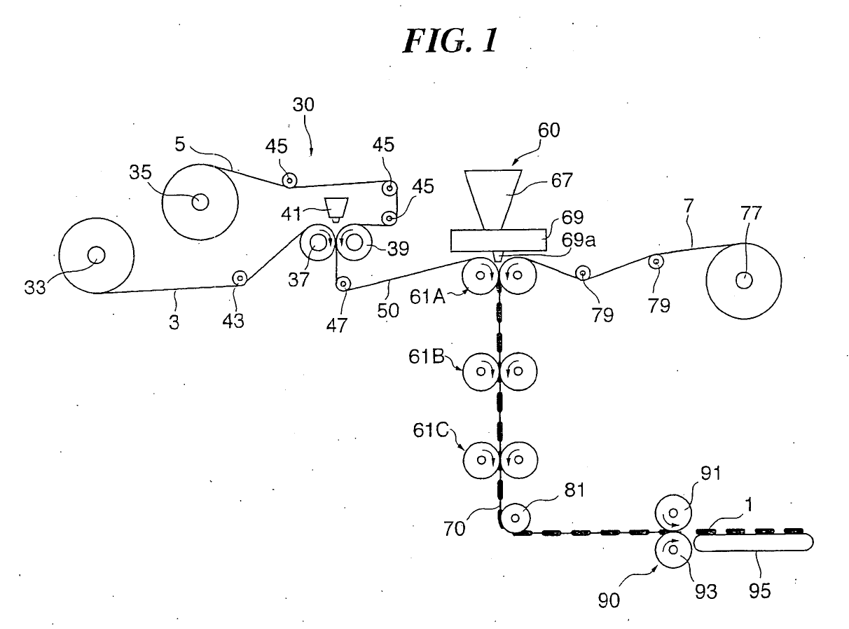

FIG. 2 are drawings showing each layer passed the adhesive layer forming process, FIG. 2(A) is a plane drawing and FIG. 2(B) is a cross-sectional drawing;

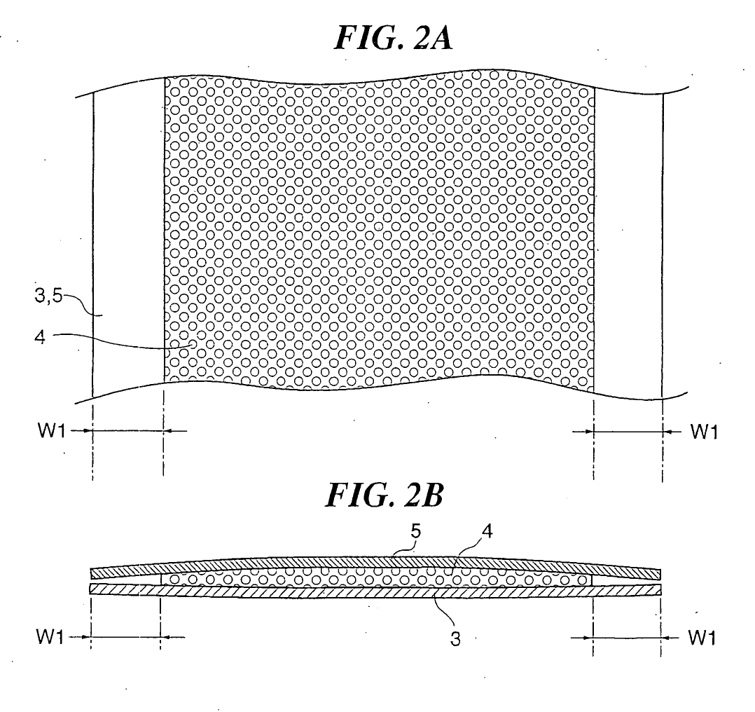

FIG. 3 are drawings schematically showing the pocket forming and adhesive gathering process (B process) and the pocket sealing process (C process), FIG. 3(A) is a perspective drawing, FIG. 3(B) is a cross-sectional drawing and FIG. 3(C) is an enlarged drawing showing a seal roll used in the processes;

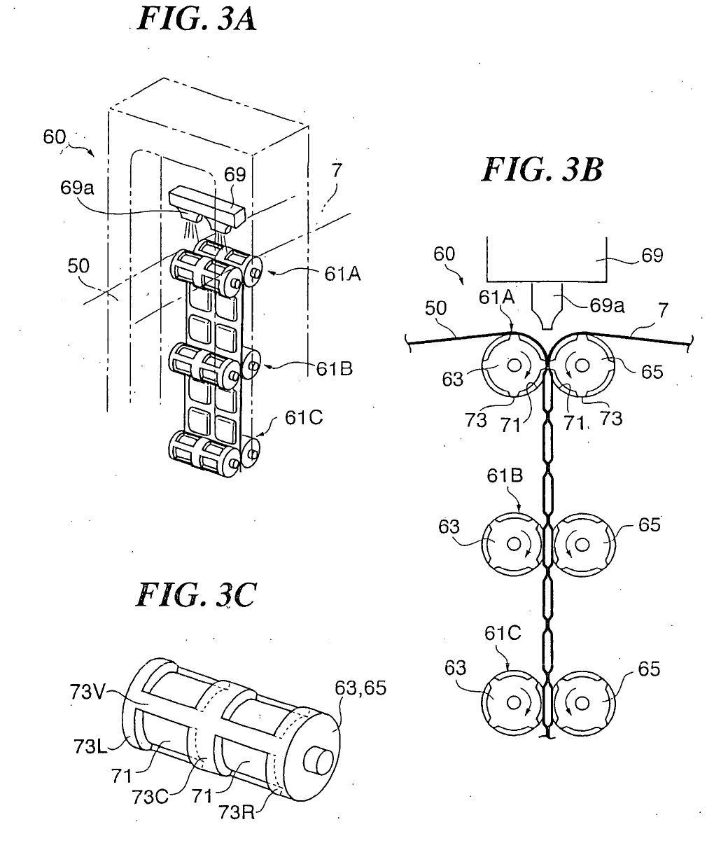

FIG. 4 is a drawing schematically showing a state in which the films are passing through the contact zone;

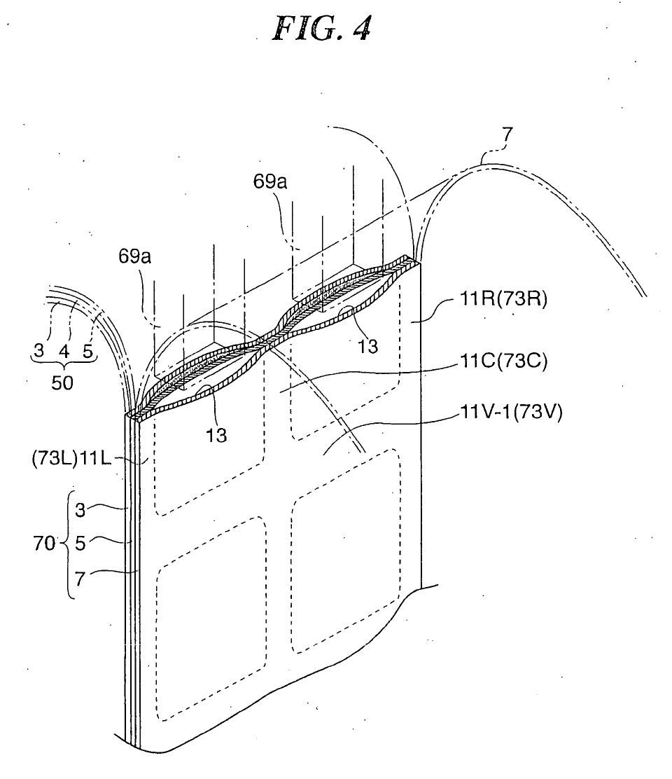

FIG. 5 are drawings showing each layer after passing the contact zone, FIG. 5(A) is a plane drawing and FIG. 5(B) is a cross-sectional drawing;

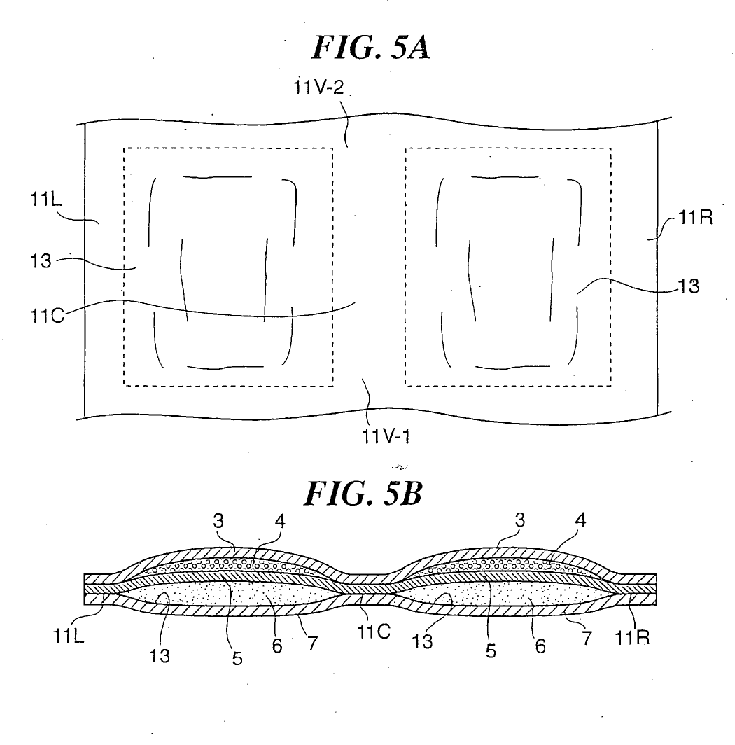

FIG. 6 are drawings showing a structure of the adhesive type heat-generation. FIG. 6(A) is a plane drawing and FIG. 6(B) is a cross-section drawing;

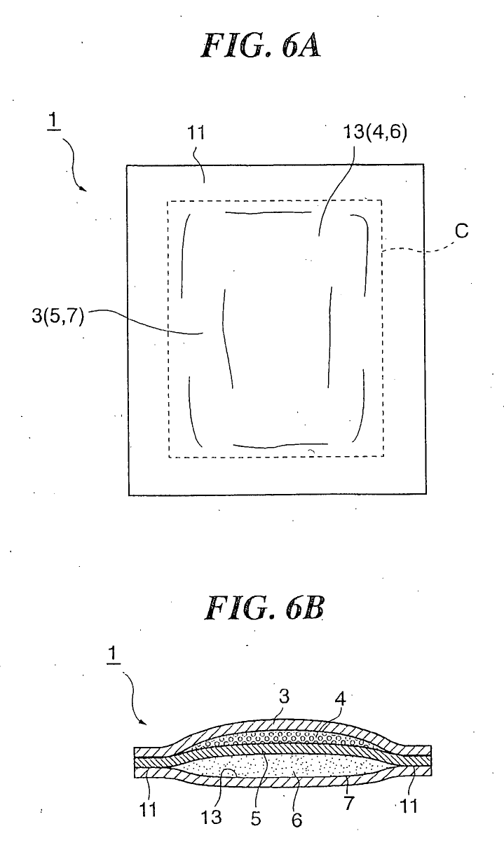

FIG. 7 is a drawing showing the cutting process;

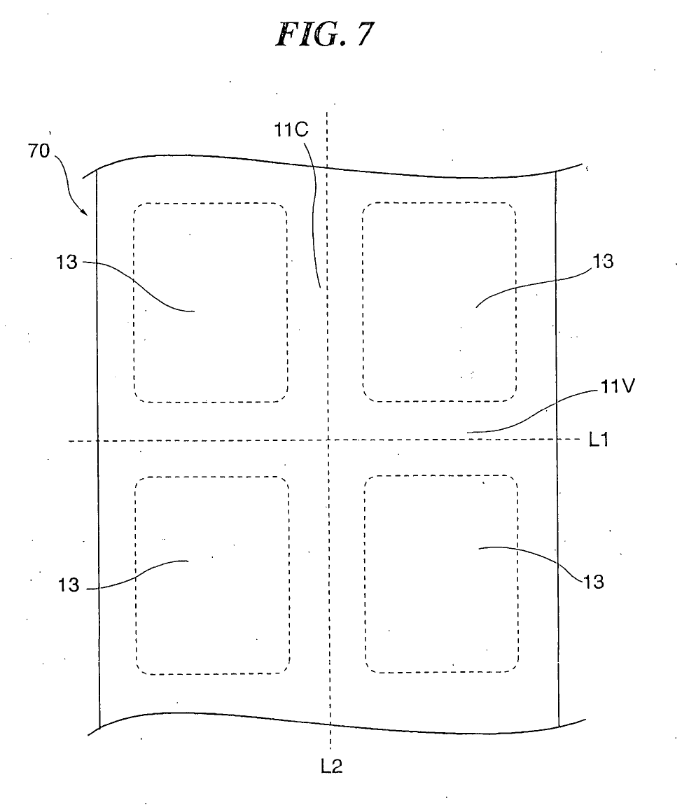

FIG. 8 are drawings showing shapes of the pocket.

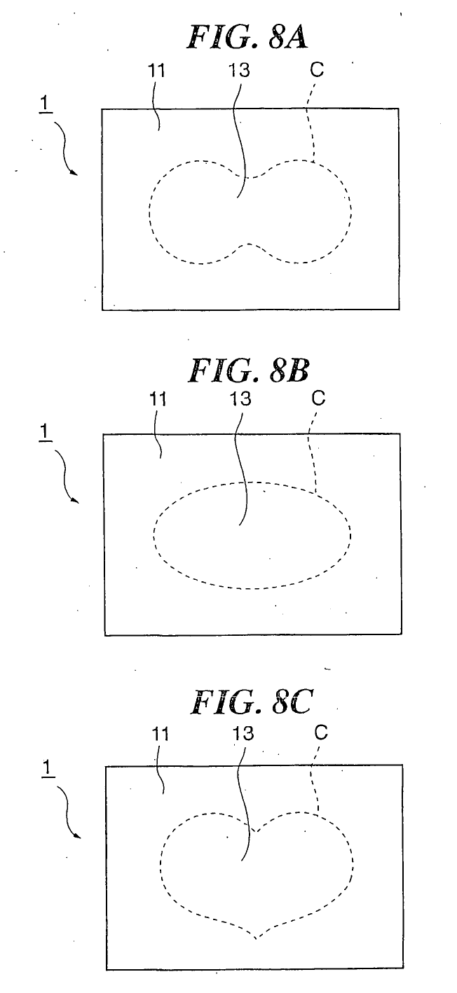

### EXPLANATION OF REFERENCES

1 adhesive type heat-generation
3 release film
4 adhesive layer
5 base film
6 heating composition
7 air-permeable film
11 peripheral edge (heat-sealed portion)
13 pocket
30 adhesive layer forming process
33 release film roll
35 base film roll
37 coater roll
39 clearance roll
41 hopper
43,45,47 tension roll
50 three-layered film
60 a pocket forming and adhesive gathering process
61 seal roll pair
63,65 seal rolls
67 hopper
69 measuring apparatus
69a outlet
70 sheet
71 concave portion
73 border portion
75 tension roll
81 tension roll
90 cutting process
91,93 rotary blades
95 belt conveyer

1-4. (canceled)

5. A process for producing an adhesive type heat-generation comprising a release film, a hydrous hydrophilic adhesive layer, a base film, a heating composition layer and an air-permeable film stacking up in the order comprising:
A process in which said hydrous hydrophilic adhesive layer is spread and sandwiched between said release film and said base film in a predetermined thickness while continuously feeding said release film and said base film from respective rolls to form said adhesive layer;
B process in which said base film on its side opposite to said adhesive layer and said air-permeable film are joined, peripheral edges of said films are melt-bonded to form a heat-sealed peripheral edge and thus to form a pocket between said base film and said air-permeable film for containing a heating composition, and simultaneously therewith, an adhesive of said adhesive layer is pushed and gathered inside said heat-sealed peripheral edge; and
C process in which said heating composition layer is formed in said pocket and sealed said pocket at the same time of, or, before or after the formation of said pocket,
wherein said adhesive is spread on an inside area at a predetermined distance from both side edges of said release film in said A process and
a contour of a planer area on which said adhesive layer is applied is substantially conformed to a contour of said pocket in said B process.

6. The process for producing an adhesive type heat-generation according to claim 5,
wherein said adhesive type heat-generation will be mass-produced by arranging said heat-generations in the longitudinal and width directions of the film, and then said film will be cut along said heat-sealed portions so as to divide each adhesive type heat-generation individually.

7. The process for producing an adhesive type heat-generation according to claim 5,
wherein a plane on which said adhesive layer is applied is made into a gourd-shape, a heart-shape or an oval shape.

8. The process for producing an adhesive type heat-generation according to claim 6,
wherein a plane on which said adhesive layer is applied is made into a gourd-shape, a heart-shape or an oval shape.
